(19) United States
(12) Patent Application Publication
(10) Pub. No.: US 2025/0091648 A1
(43) Pub. Date: Mar. 20, 2025

(54) JOINT STRUCTURE OF VEHICLE BODY

(71) Applicants: Hyundai Motor Company, Seoul (KR); Kia Corporation, Seoul (KR)

(72) Inventors: Won Ki Song, Hwaseong-si (KR); Jung Taek Lim, Hwaseong-si (KR); Jaeseung Lee, Hwaseong-si (KR); Sun Hyung Cho, Hwaseong-si (KR); Dae Hee Lee, Hwaseong-si (KR); Jin Ho Hwang, Hwaseong-si (KR); Joonghyun Shin, Hwaseong-si (KR); Hyungsik Choi, Hwaseong-si (KR)

(21) Appl. No.: 18/800,448

(22) Filed: Aug. 12, 2024

(30) Foreign Application Priority Data
Sep. 20, 2023 (KR) 10-2023-0125390

(51) Int. Cl. B62D 24/02; B62D 27/06

(52) U.S. Cl. CPC B62D 24/02; B62D 27/06

(57) ABSTRACT

An embodiment joint structure of a vehicle body includes a front body module fixed to a front portion of a center floor member of an underbody of the vehicle body, wherein the front body module is a fixed part, a rear body module detachably fixed to a rear portion of the center floor member and a rear portion of the front body module in a set shape, wherein the rear body module is a variable part, a plurality of center floor member coupling modules disposed on the center floor member at the rear portion of the front body module, and a plurality of variable part coupling modules disposed at a lower side of the rear body module and configured to be coupled to the center floor member coupling modules by electromagnetic force.

### CROSS-REFERENCE TO RELATED APPLICATIONS

This application claims the benefit of Korean Patent Application No. 10-2023-0125390, filed on Sep. 20, 2023, which application is hereby incorporated herein by reference.

### TECHNICAL FIELD

The present disclosure relates to a joint structure of a vehicle body.

### BACKGROUND

Recently, the automobile industry is introducing a new concept of future mobility vision for realization of a human-centered, dynamic future city. One of these future mobility solutions is a purpose built vehicle (PBV) as a purpose-based mobility.

The PBV may be an example of an electric vehicle (EV)-based eco-friendly mobile vehicle. The PBV may provide various customized services to users while traveling from an origin to a destination in an unmanned or manned autonomous driving method.

A vehicle body of the PBV includes an underbody (it is also called a chassis frame, a rolling chassis, or a skateboard by those skilled in the art) and an upper body assembled to the underbody.

Here, the upper body may be configured in various forms depending on a type of customized service of the PBV. For example, the PBV may be used as a hailing type vehicle in which cabins are configured in front and rear portions of the upper body, respectively. Furthermore, the PBV may also be used as a cab type vehicle in which a cabin is configured only in the front portion of the upper body. Furthermore, the PBV may be used as a delivery type vehicle in which a cabin is configured in a front portion of an upper body and a luggage room is configured in a rear portion.

According to the existing technology, costs of changing the structure of the upper body may increase according to various customized services of the PBV as described above. Therefore, there is a need to develop the joint structure of a vehicle body that can be changed into various types of vehicle bodies depending on the type of customized service for the PBV.

### SUMMARY

The present disclosure relates to a joint structure of a vehicle body. Particular embodiments relate to a joint structure of a vehicle body including a fixed part and a variable part in a PBV.

Embodiments of the present disclosure provide a joint structure of a vehicle body in which front and rear portions of an upper body are configured to be detachable and rigidity and vibration insulation are secured at a detachable portion.

According to an embodiment of the present disclosure, a joint structure of a vehicle body includes a front body module as a fixed part fixed to a front portion of a center floor member of an underbody of a vehicle, a rear body module as a variable part, which is detachable to a rear portion of the center floor member and a rear portion of the front body module, in a set shape, a plurality of center floor member coupling modules installed on the center floor member of the rear portion of the front body module, and a plurality of variable part coupling modules installed below the rear body module and coupled to the center floor member coupling modules by electromagnetic force.

The center floor member may include a center floor lower member and a center floor upper member coupled to an upper portion of the center floor lower member.

The plurality of center floor member coupling modules may include a pair of bulk heads that are installed inside the center floor lower member and arranged to be spaced apart along a longitudinal direction of the center floor lower member, and the center floor upper member may be coupled to cover the upper portion of the center floor lower member to form an accommodation space between the pair of bulk heads.

The bulk head may be made of a steel material.

The plurality of center floor member coupling modules may include a magnetic member inserted into the accommodation space.

The magnetic member may be formed with a coupling groove in which variable part magnetic members provided in the plurality of variable part coupling modules are inserted into and coupled to.

The magnetic member may not be inserted into the accommodation space and may have a pair of wing parts extending along an upper surface of the center floor upper member.

The magnetic member may be bolted to an inner side surface of the center floor upper member and a lower surface of the center floor lower member within the accommodation space, and the pair of wing parts may be bolted to the upper surface of the center floor upper member.

The magnetic member may be bolted to the inner side surface of the center floor upper member only on a side surface of the magnetic member facing an outer side of the vehicle.

The plurality of center floor member coupling modules may further include a magnetic bush inserted into the accommodation space and supported by the pair of bulk heads, and the magnetic member may be arranged to be inserted into the magnetic bush.

An inner side surface of the magnetic bush and an outer side surface of the magnetic member may be fixed by male-female coupling between a groove and a valley.

The groove and the valley may be formed in a cross shape.

The magnetic bush may be made of a rubber material.

The magnetic bush may be formed with a pair of protrusions that are formed to be higher than heights of the magnetic member inserted into the magnetic bush and the center floor upper member and extend along the longitudinal direction of the center floor member.

According to an embodiment of the present disclosure, it is possible to reduce costs caused by changing the upper body structure of the vehicle body to suit various customized services of the PBV.

In addition, it is possible to secure the coupled rigidity and skeletal rigidity of the front and rear body modules, which are detachable from each other, and secure the mounting rigidity of the magnetic joint structure.

In addition, by applying the magnetic bush, it is possible to absorb the vibration of the magnetic joint structure and shield the electromagnetic waves.

### BRIEF DESCRIPTION OF THE DRAWINGS

FIG. 1 is a perspective view illustrating a joint structure of a vehicle body according to an embodiment of the present disclosure.

FIG. 2 is a perspective view illustrating a center floor member coupling module according to an embodiment of the present disclosure.

FIG. 3 is a perspective view illustrating a state in which a bulk head of the center floor member coupling module according to an embodiment of the present disclosure is installed on a center floor member.

FIG. 4 is a cross-sectional view taken along line A-A of FIG. 3.

FIG. 5 is a perspective view illustrating a state in which the bulk head and a magnetic member of the center floor member coupling module according to an embodiment of the present disclosure are installed on the center floor member.

FIG. 6 is a cross-sectional view taken along line B-B of FIG. 5.

FIG. 7 is a cross-sectional view taken along line C-C of FIG. 5.

FIG. 8 is a perspective view illustrating a state in which the bulk head, the magnetic member, and a magnetic bush of the center floor member coupling module according to an embodiment of the present disclosure are installed on the center floor member.

FIG. 9 is a perspective view illustrating a state before the magnetic member and the magnetic bush of the center floor member coupling module according to an embodiment of the present disclosure are coupled.

FIG. 10 is a perspective view illustrating the state after the magnetic member and the magnetic bush of the center floor member coupling module according to an embodiment of the present disclosure are coupled.

FIG. 11 is a perspective view illustrating the state after the magnetic member, the bulk head, and the magnetic bush of the center floor member coupling module according to an embodiment of the present disclosure are coupled.

FIG. 12 is a cross-sectional view taken along line D-D of FIG. 8.

FIG. 13 is a cross-sectional view illustrating a state in which a variable part coupling module is coupled to the center floor member coupling module illustrated in FIG. 12.

### DETAILED DESCRIPTION OF ILLUSTRATIVE EMBODIMENTS

Hereinafter, embodiments of the present disclosure will be described in detail with reference to the accompanying drawings so that those skilled in the art to which the present disclosure pertains may easily practice embodiments of the present disclosure. However, the present disclosure may be implemented in various different forms and is not limited to embodiments provided herein.

In addition, in several embodiments, components having the same configuration will be representatively described using the same reference numerals in an embodiment, and only components different from those of an embodiment will be described in the other embodiments.

Note that the drawings are schematic and not drawn to scale. The relative dimensions and ratios of parts in the drawing are shown exaggerated or reduced in size for clarity and convenience in the drawing, and any dimensions are illustrative only and not limiting. In addition, the same reference sign is used to indicate similar features of two or more of the same structure, element, or part appearing in the drawing. When a part is referred to as being “on” another part, it may be directly on top of the other part, or it may be accompanied by another part in between.

Embodiments of the present disclosure specifically represent exemplary embodiments of the present disclosure. As a result, numerous variations of the illustration are expected. Accordingly, the embodiments are not limited to a specific form of the illustrated area, and include, for example, a deformation of the form by manufacturing.

Hereinafter, a joint structure of a vehicle body according to embodiments of the present disclosure will be described in detail with reference to the accompanying drawings.

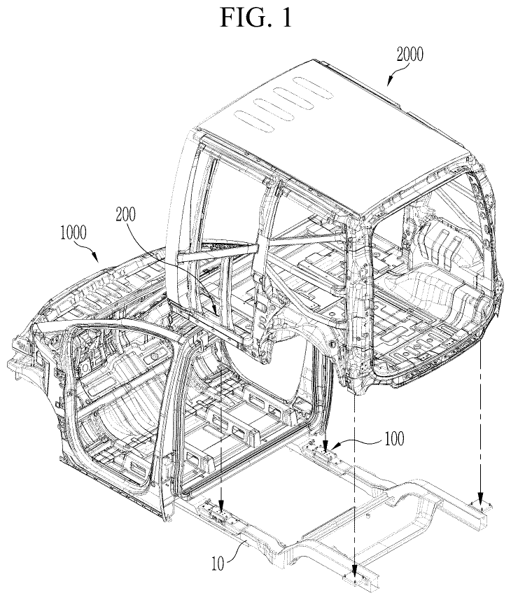

FIG. 1 is a perspective view illustrating a joint structure of a vehicle body according to an embodiment of the present disclosure.

Referring to FIG. 1, the joint structure of a vehicle body according to an embodiment of the present disclosure may be applied to a vehicle body of, for example, a purpose built vehicle (hereinafter referred to as a ‘PBV’).

The PBV may be used as an electric vehicle-based life module vehicle that provides various customized services to users while traveling from an origin to a destination.

In an embodiment, the PBV may be manufactured in a one box type of design with a large interior space. Furthermore, the PBV may also apply facing-type seats to the interior space.

The vehicle body of such a PBV is suitable for small-scale production of various vehicle types with a small number of parts and may be manufactured in various shapes and sizes.

Furthermore, the vehicle body of the PBV includes a skateboard type underbody (commonly referred to as a ‘rolling chassis’ or a ‘chassis frame’ by those skilled in the art) and an upper body assembled to the underbody.

Components such as a battery assembly and a drive motor may be mounted on the underbody. In addition, the upper body is a body-in-white (BIW) body coupled to the underbody, and it may include a cabin and a luggage room of a large interior space.

The joint structure of a vehicle body according to an embodiment of the present disclosure has a structure so that the upper body of various shapes and purposes may be applied to the underbody depending on the type of customized service for the PBV.

To this end, the joint structure of a vehicle body according to an embodiment of the present disclosure is an upper body and includes a front body module 1000 and a rear body module 2000.

In an embodiment, the front body module 1000 includes a cab type front cabin. The front body module 1000 may be fixed to a front portion of the underbody.

In an embodiment of the invention, the rear body module 2000 includes a rear cabin or a luggage room. The rear body module 2000 is detachably provided at a rear portion of the underbody and a rear portion of the front body module 1000.

Here, the rear body module 2000 may be detached from the rear portion of the underbody in a vertical direction. In addition, the rear body module 2000 may be detached from the rear portion of the front body module 1000 along a front-to-rear direction of the vehicle body. The rear body module 2000 may be manufactured in various shapes depending on the purpose of the PBV.

The front body module 1000 may be fixed to a front portion of a center floor member 10 of the underbody, and the rear body module 2000 may be detachably fixed to a rear portion of the center floor member 10 of the underbody.

The rear body module 2000 and the center floor member 10 may be coupled together by vertical coupling between a plurality of center floor member coupling modules 100 and a plurality of variable part coupling modules 200.

The center floor member coupling modules 100 may be provided on the center floor member 10. The variable part coupling modules 200 may be provided in a lower portion of a variable part to face the center floor member coupling modules 100 at positions corresponding to the center floor member coupling modules 100. These center floor member coupling modules 100 and the variable part coupling modules 200 may be coupled by electromagnetic force.

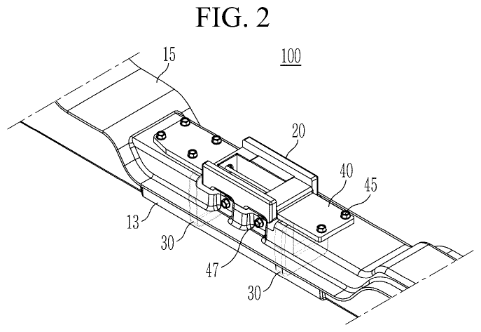

FIG. 2 is a perspective view illustrating the center floor member coupling module according to an embodiment of the present disclosure.

Referring to FIG. 2, the center floor member 10 may include a center floor lower member 13 installed on the underbody and a center floor upper member 15 coupled to an upper portion of the center floor lower member 13.

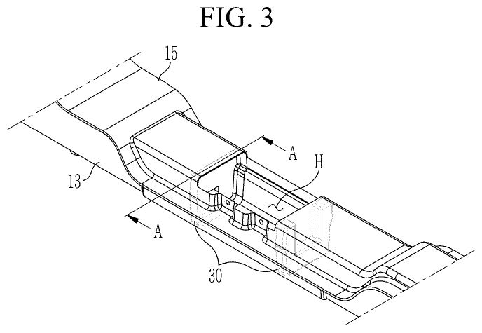

The center floor members 10 may be provided in pairs on both portions of the underbody along a longitudinal direction of the vehicle body. The center floor member coupling modules 100 may be installed on the center floor members 10 on both sides, respectively. That is, the center floor lower member 13 and the center floor upper member 15 form a magnetic mounting passing hole H when coupled (see FIG. 3), and the center floor member coupling module 100 may be inserted into and installed on the magnetic mounting passing hole H. The center floor member coupling module 100 may be bolted and fixed to the center floor lower member 13 and the center floor upper member 15 by bolts 45, 47, and 49.

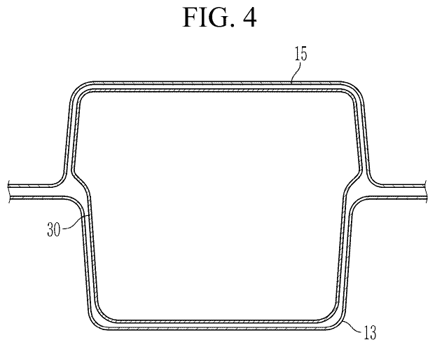

FIG. 3 is a perspective view illustrating a state in which a bulk head of the center floor member coupling module according to an embodiment of the present disclosure is installed on the center floor member. FIG. 4 is a cross-sectional view taken along line A-A of FIG. 3.

Referring to FIGS. 3 and 4, the center floor member coupling module 100 may include a bulk head 30. A pair of bulk heads 30 may be installed on an inner side of the center floor lower member 13 to be spaced apart at a certain interval along a longitudinal direction of the center floor lower member 13. This pair of bulk heads 30 is installed on both sides of the magnetic mounting passing hole H to form an accommodation space into which the center floor member coupling modules 100 may be inserted. The center floor upper member 15 is coupled to cover the upper portion of the center floor lower member 13 to form the accommodation space between the pair of bulk heads 30.

The bulk head 30 may be made of a steel material. The bulk head 30 may support a lower surface and a side surface of the center floor lower member 13, and it may support an upper surface and a side surface of the center floor upper member 15 to secure the rigidity of the center floor member 10 and maintain a shape of the accommodation space.

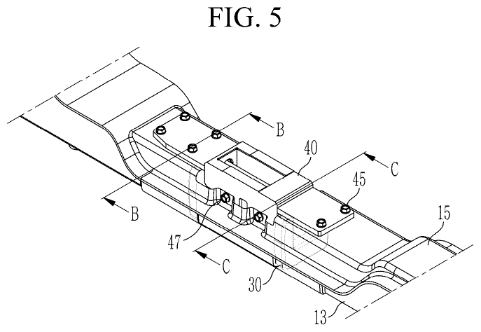

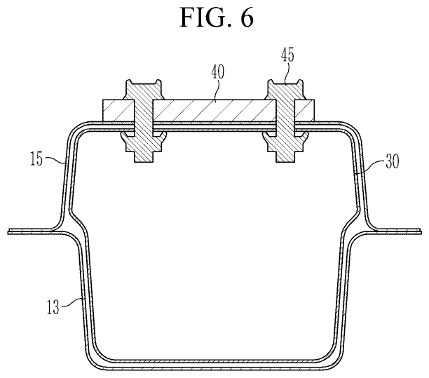

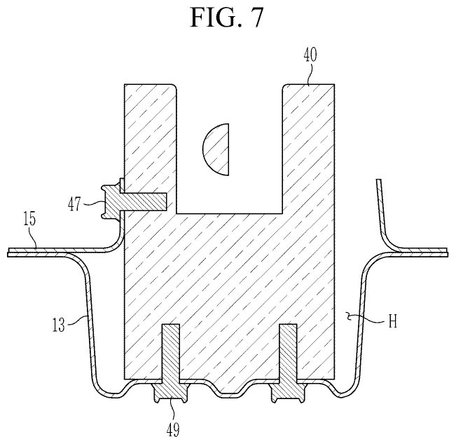

FIG. 5 is a perspective view illustrating a state in which the bulk head and a magnetic member of the center floor member coupling module according to an embodiment of the present disclosure are installed on the center floor member. FIG. 6 is a cross-sectional view taken along line B-B of FIG. 5. FIG. 7 is a cross-sectional view taken along line C-C of FIG. 5.

Referring to FIG. 5, the center floor member coupling module 100 may further include a magnetic member 40. The magnetic member 40 may be inserted into and installed on the accommodation space formed by the center floor lower member 13, the center floor upper member 15, and the pair of bulk heads 30.

A coupling groove may be formed in the central portion of the magnetic member 40, that is, a portion corresponding to the accommodation space. A variable part magnetic member 50 included in the variable part coupling modules 200 provided in a lower portion of the rear body module 2000 is inserted into the coupling groove, so that the rear body module 2000 and the center floor member 10 may be coupled.

A pair of wing parts extending along the upper surface of the center floor upper member 15 may be provided on both sides of the magnetic member 40. The wing part is not inserted into the accommodation space, but is coupled to the upper surface of the center floor upper member 15 by the bolt 45. The pair of wing parts may be formed to have different lengths and shapes depending on the shape of the center floor upper member 15. For example, the wing part on one side may be formed to have a shorter length than the wing part on the other side, the wing part on one side may be coupled to the center floor upper member 15 by two bolts 45, and the wing part on the other side may be coupled to the center floor upper member by four bolts 45.

As illustrated in FIG. 6, the bolts 45 are arranged side by side in a direction perpendicular to the longitudinal direction of the center floor member 10 to couple the wing part and the center floor upper member 15.

Meanwhile, as illustrated in FIG. 7, the central portion of the magnetic member 40 inserted into the accommodation space may be coupled to an inner side surface and a lower surface of the center floor upper member 15 by the bolts 47 and 49. A central side surface of the magnetic member 40 may be fixed to the inner side surface of the center floor upper member 15 by two bolts 47. An opposite side of the magnetic member 40 to the fixed portion may not be fixed. A central lower surface of the magnetic member 40 may be coupled to the center floor lower member 13 by four bolts 49.

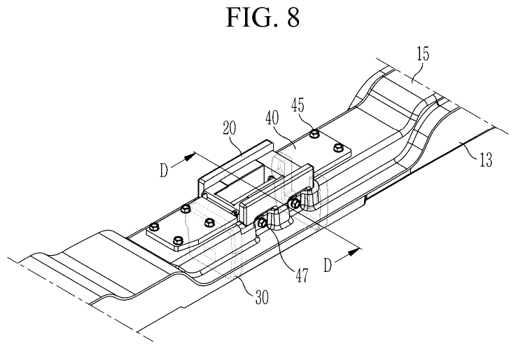

FIG. 8 is a perspective view illustrating a state in which the bulk head, the magnetic member, and a magnetic bush of the center floor member coupling module according to an embodiment of the present disclosure are installed on the center floor member.

Referring to FIG. 8, the center floor member coupling module 100 may further include a magnetic bush 20 inserted into the accommodation space and supported by the pair of bulk heads 30. The magnetic member 40 may be arranged to be inserted into the magnetic bush 20. A space may be formed in the central portion of the magnetic bush 20 so that the central portion of the magnetic member 40 may be inserted, and the magnetic member 40 may be inserted into the magnetic bush 20 and fitted.

The magnetic bush 20 may be made of a rubber material. The magnetic bush 20 may absorb vibration of the magnetic member 40 and shield electromagnetic waves.

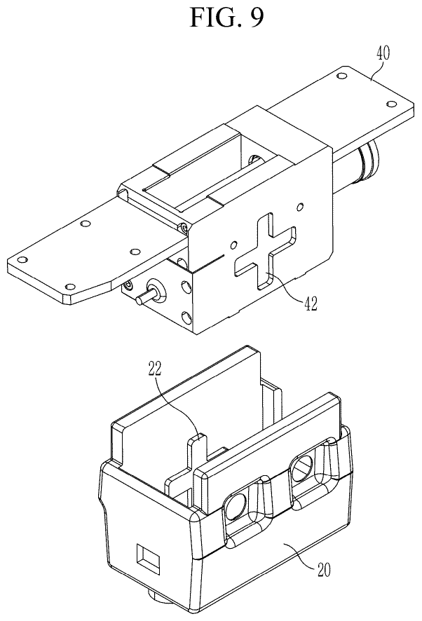

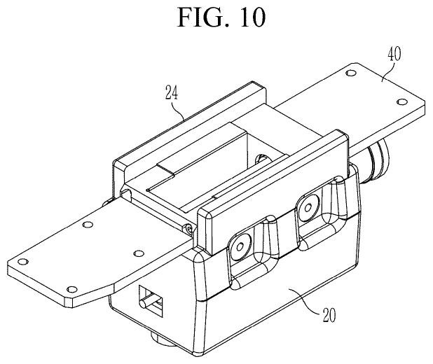

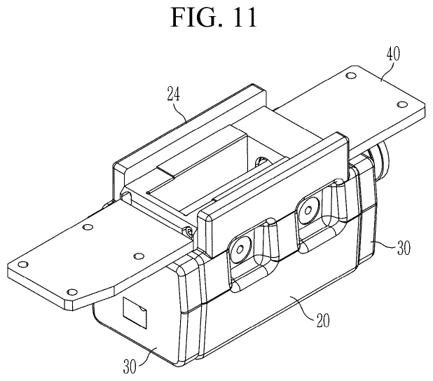

FIG. 9 is a perspective view illustrating a state before the magnetic member and the magnetic bush of the center floor member coupling module according to an embodiment of the present disclosure are coupled. FIG. 10 is a perspective view illustrating the state after the magnetic member and the magnetic bush of the center floor member coupling module according to an embodiment of the present disclosure are coupled. FIG. 11 is a perspective view illustrating the state after the magnetic member, the bulk head, and the magnetic bush of the center floor member coupling module according to an embodiment of the present disclosure are coupled.

As illustrated in FIG. 9, the central portion of the magnetic member 40 is inserted into the space of the central portion of the magnetic bush 20, and when inserted, an inner side surface of the magnetic bush 20 and an outer side surface of the magnetic member 40 may be fixed by male-female coupling between a groove 42 and a valley 22. The groove 42 and the valley 22 may be formed in a cross shape to prevent the magnetic bush 20 and the magnetic member 40 from shaking up, down, left, and right with respect to each other.

As illustrated in FIG. 10, when the magnetic member 40 and the magnetic bush 20 are coupled, an opening may be formed on a side surface of the magnetic bush 20 so that a portion where the magnetic member 40 and the center floor upper member 15 are bolted is exposed.

As illustrated in FIG. 11, the magnetic bush 20 may be supported by the bulk head 30 on both sides, and the center floor member coupling module 100, in which the magnetic member 40, the magnetic bush 20, and the bulk head 30 are coupled, is inserted into the accommodation space of the center floor member 10.

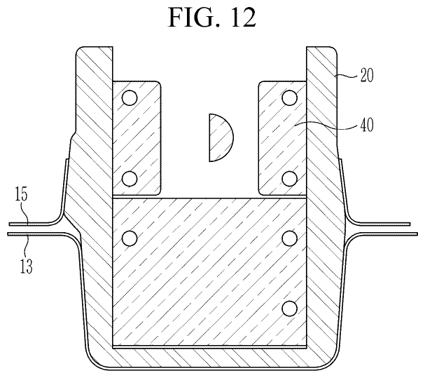

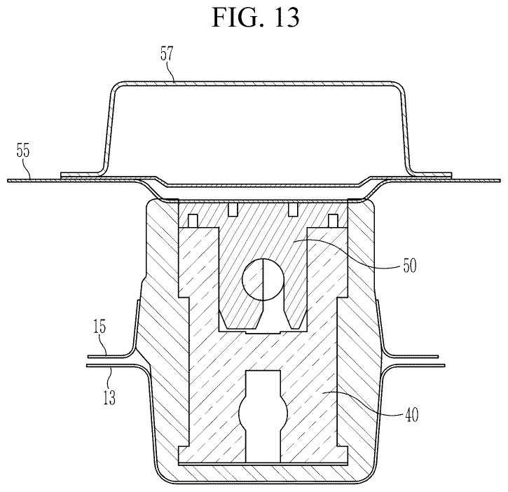

FIG. 12 is a cross-sectional view taken along line D-D of FIG. 8. FIG. 13 is a cross-sectional view illustrating a state in which the variable part coupling module is coupled to the center floor member coupling module illustrated in FIG. 12.

As illustrated in FIGS. 11 and 12, the magnetic bush 20 has a pair of protrusions 24 formed to be higher than the heights of the magnetic member 40 and the center floor upper member 15 while the center floor member coupling module 100 is inserted into the center floor member 10.

In addition, as illustrated in FIG. 13, when the rear body module 2000 is coupled to the center floor member 10, the magnetic member 50 of the variable part coupling module 200 installed on the rear body module 2000 is inserted into and coupled to the magnetic member 40 of the center floor member coupling module 100. The magnetic member 50 of the variable part coupling module 200 is coupled to a lower surface of a variable part floor panel 55 coupled to a lower portion of a variable part floor member 57, and the variable part floor panel 55 contacts the upper surface of the center floor upper member 15.

The magnetic member 50 of the variable part coupling module 200 and the magnetic member 40 of the center floor member coupling module 100 are male-female coupled, and the protrusions 24 of the magnetic bush 20 may absorb the variation of the magnetic member 50 of the variable part coupling module 200 and serve to shield the electromagnetic waves.

As described above, according to an embodiment of the present disclosure, it is possible to reduce costs caused by changing the upper body structure of the vehicle body to suit various customized services of the PBV.

In addition, it is possible to secure the coupled rigidity and skeletal rigidity of the front and rear body modules, which are detachable from each other, and secure the mounting rigidity of the magnetic joint structure.

In addition, by applying the magnetic bush, it is possible to absorb the vibration of the magnetic joint structure and shield the electromagnetic waves.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

The following reference identifiers may be used in connection with the drawings to describe various features of embodiments of the present disclosure.
1000: Front body module
2000: Rear body module
100: Center floor member coupling module
200: Variable part coupling module
10: Center floor member
13: Center floor lower member
15: Center floor upper member
20: Magnetic bush
22: Valley
24: Protrusion
30: Bulk head
40, 50: Magnetic member
42: Groove
45, 47, 49: Bolt
H: Magnetic mounting passing hole
55: Variable part floor panel
57: Variable part floor member

What is claimed is:

1. A joint structure of a vehicle body, the joint structure comprising:
a front body module fixed to a front portion of a center floor member of an underbody of the vehicle body, wherein the front body module is a fixed part;
a rear body module detachably fixed to a rear portion of the center floor member and a rear portion of the front body module in a set shape, wherein the rear body module is a variable part;
a plurality of center floor member coupling modules disposed on the center floor member at the rear portion of the front body module; and
a plurality of variable part coupling modules disposed at a lower side of the rear body module and configured to be coupled to the center floor member coupling modules by electromagnetic force.

2. The joint structure of claim 1, wherein the center floor member comprises:
a center floor lower member; and
a center floor upper member coupled to an upper portion of the center floor lower member.

3. The joint structure of claim 2, wherein:
the plurality of center floor member coupling modules comprises a pair of bulk heads disposed inside the center floor lower member and arranged to be spaced apart along a longitudinal direction of the center floor lower member; and
the center floor upper member is coupled to cover the upper portion of the center floor lower member to define an accommodation space between the pair of bulk heads.

4. The joint structure of claim 3, wherein the pair of bulk heads comprises a steel material.

5. The joint structure of claim 3, wherein the plurality of center floor member coupling modules further comprises a magnetic member insertable into the accommodation space.

6. The joint structure of claim 5, wherein:
the plurality of center floor member coupling modules further comprises a magnetic bush inserted into the accommodation space and supported by the pair of bulk heads; and
the magnetic member is arranged to be inserted into the magnetic bush.

7. The joint structure of claim 6, wherein an inner side surface of the magnetic bush and an outer side surface of the magnetic member are fixed by male-female coupling between a groove and a valley.

8. The joint structure of claim 7, wherein the groove and the valley each comprise a cross shape.

9. The joint structure of claim 6, wherein the magnetic bush comprises a rubber material.

10. The joint structure of claim 6, wherein the magnetic bush comprises a pair of protrusions that extend higher than heights of the magnetic member inserted into the magnetic bush and the center floor upper member and extend along the longitudinal direction of the center floor member.

11. A joint structure of a vehicle body, the joint structure comprising:
a front body module fixed to a front portion of a center floor member of an underbody of the vehicle body, wherein the front body module is a fixed part, and wherein the center floor member comprises a center floor lower member and a center floor upper member coupled to an upper portion of the center floor lower member;
a rear body module detachably fixed to a rear portion of the center floor member and a rear portion of the front body module in a set shape, wherein the rear body module is a variable part;
a plurality of center floor member coupling modules disposed on the center floor member at the rear portion of the front body module, wherein the plurality of center floor member coupling modules comprises a pair of bulk heads disposed inside the center floor lower member and arranged to be spaced apart along a longitudinal direction of the center floor lower member, wherein the center floor upper member is coupled to cover the upper portion of the center floor lower member to define an accommodation space between the pair of bulk heads, and wherein the plurality of center floor member coupling modules further comprises a magnetic member insertable into the accommodation space, the magnetic member comprising a coupling groove; and
a plurality of variable part coupling modules disposed at a lower side of the rear body module and configured to be coupled to the center floor member coupling modules by electromagnetic force, wherein variable part magnetic members in the plurality of variable part coupling modules are insertable into and couplable to the coupling groove of the magnetic member.

12. The joint structure of claim 11, wherein an entirety of the magnetic member is not inserted into the accommodation space, and the magnetic member comprises a pair of wing parts extending along an upper surface of the center floor upper member.

13. The joint structure of claim 12, wherein:
the magnetic member is coupled to an inner side surface of the center floor upper member and a lower surface of the center floor lower member within the accommodation space by first bolts; and
the pair of wing parts are coupled to the upper surface of the center floor upper member by second bolts.

14. The joint structure of claim 13, wherein the magnetic member is coupled to the inner side surface of the center floor upper member only on a side surface of the magnetic member facing an outer side of the vehicle body.

15. The joint structure of claim 11, wherein the pair of bulk heads comprises a steel material.

16. A vehicle body comprising:
an underbody comprising a center floor member extending in a longitudinal direction of the vehicle body, the center floor member comprising a center floor lower member and a center floor upper member coupled to an upper portion of the center floor lower member to define an accommodation space;
a front body module fixed to a front portion of the center floor member;
a rear body module detachably fixed to a rear portion of the center floor member and a rear portion of the front body module;
a plurality of center floor member coupling modules disposed on the center floor member at the rear portion of the front body module, the plurality of center floor member coupling modules comprising a pair of bulk heads disposed inside the center floor lower member and spaced apart along a longitudinal direction of the center floor lower member, wherein the accommodation space is defined between the pair of bulk heads; and
a plurality of variable part coupling modules disposed at a lower side of the rear body module and configured to be coupled to the center floor member coupling modules by electromagnetic force.

17. The vehicle body of claim 16, wherein the plurality of center floor member coupling modules further comprises:
a magnetic bush inserted into the accommodation space; and
a magnetic member inserted into the magnetic bush inside the accommodation space.

18. The vehicle body of claim 17, wherein an inner side surface of the magnetic bush and an outer side surface of the magnetic member are fixed by male-female coupling between a groove and a valley.

19. The vehicle body of claim 18, wherein the groove and the valley each comprise a cross shape.

20. The vehicle body of claim 17, wherein the magnetic bush comprises a pair of protrusions that extend higher than heights of the magnetic member inserted into the magnetic bush and the center floor upper member and extend along the longitudinal direction of the center floor member.
